(19) United States
(12) Patent Application Publication
(10) Pub. No.: US 2014/0309113 A1
(43) Pub. Date: Oct. 16, 2014

(54) Pesticide Composition Having Improved Rainfastness

(71) Applicant: BASF SE, Lugwigshafen (DE)

(72) Inventors: Alan K. Viets, Hamilton, OH (US); David Przybyla, Charlotte, NC (US)

(73) Assignee: Basf SE, Lugwigshafen (DE)

(21) Appl. No.: 14/357,437

(22) PCT Filed: Nov. 9, 2012
(86) PCT No.: PCT/IB2012/002986

§ 371 Date: May 9, 2014

Related U.S. Application Data
(60) Provisional application No. 61/558,733, filed on Nov. 11, 2011.

(51) Int. Cl. A01N 25/32; A01N 57/20

(52) U.S. Cl. CPC A01N 25/32; A01N 57/20
USPC 504/127; 514/114; 504/206

(57) ABSTRACT

A pesticide composition includes an active component and polyethyleneimine having a weight average molecular weight of at least about 750,000 g/mol and has improved rainfastness. The polyethyleneimine of this invention has decreased mobility in water as compared to related lower molecular weight analogs. The pesticide composition is formed using a method that includes the steps of providing the active component, providing the polyethyleneimine, and combining the active component and the polyethyleneimine to form the pesticide composition.

### FIELD OF THE INVENTION

The present invention generally relates to a pesticide composition that has improved rainfastness. More specifically, the present invention relates to a pesticide composition that includes polyethyleneimine having a particular weight average molecular weight.

### DESCRIPTION OF THE RELATED ART

Use of pesticide compositions is essential in farming and agricultural industries. In these industries, the pesticide compositions reduce a presence of harmful organisms and plants (such as weeds) that decrease crop yields and crop quality. However, use of pesticide compositions has disadvantages. For example, many pesticide compositions are susceptible to being prematurely rinsed off of a target due to rain or irrigation. If the pesticide composition is rinsed off of the target, the efficacy of the pesticide composition is reduced. Moreover, when rinsed off, some pesticide compositions can be undesirably toxic to organisms such as fish and other animals. Accordingly, there remains an opportunity to develop an improved pesticide composition.

### SUMMARY OF THE INVENTION AND ADVANTAGES

The present invention provides a pesticide composition having improved rainfastness. The pesticide composition includes an active component and polyethyleneimine having a weight average molecular weight of at least about 750,000 g/mol. The polyethyleneimine of this invention has an affinity for long chain fatty acids (e.g. 12 to 20 carbon atoms) found in many leaves which correlates to increased rainfastness, i.e., increased ability for the pesticide composition to resist being rinsed off of a target. The decreased rinse off also decreases potential toxicity to animals such as fish. Moreover, the hydrophobicity of the polyethyleneimine increases the attraction of the pesticide composition to plant leaves which further increases rainfastness and ultimate efficacy of the pesticide composition.

### BRIEF DESCRIPTION OF THE SEVERAL VIEWS OF THE DRAWINGS

Other advantages of the present invention will be readily appreciated, as the same becomes better understood by reference to the following detailed description when considered in connection with the accompanying drawings.

FIG. 1 is a photographic image of the Parafilm strip including Composition 1 disposed thereon, as described in the Examples.

FIG. 2 is a photographic image of the Parafilm strip including Composition 2 disposed thereon, as described in the Examples. FIG. 2 is annotated with ovals to highlight large sections of remaining fluorescence. FIG. 2 also includes a plurality of fine droplets of Composition 2 dispersed across a surface of the Parafilm strip (not annotated) which fluoresce to lighten most of the entire strip.

FIG. 3 is a photographic image of the Parafilm strip including Composition 3 disposed thereon, as described in the Examples. FIG. 3 is annotated with ovals to highlight the remaining fluorescence.

FIG. 4 is a photographic image of the Parafilm strip including Comparative Composition 1 disposed thereon, as described in the Examples. There is no remaining fluorescence in this image.

FIG. 5 is a photographic image of the Parafilm strip including Comparative Composition 2 disposed thereon, as described in the Examples. There is very little remaining fluorescence in this image.

FIG. 6 is a table that includes the percent kill of the Forage Barley plants as described in the Examples.

FIG. 7 is a table that includes the percent kill of weeds as described in the Examples.

### DETAILED DESCRIPTION OF THE INVENTION

This invention provides a pesticide composition (hereinafter referred to as a composition). The pesticide composition may be applied to a target for the purpose of, but not limited to, preventing, destroying, repelling, regulating, and/or mitigating any pest, and combinations thereof. The target is not specifically limited and may include, but is not limited to, plants, leaves, soil, crops, and combinations thereof. Alternatively, the target may include physical structures.

The composition includes an active component and polyethyleneimine having a particular weight average molecular weight. Alternatively, the composition may consist essentially of, or consist of, the active component and the polyethyleneimine. In other embodiments, the composition consists essentially of, or consists of, the active component, the polyethyleneimine, and water. The terminology “consists essentially of” typically describes that the composition is free of compounds that would adversely affect rainfastness (retention time) of the composition or efficacy of the active component. In one embodiment of the present invention, the composition is a concentrate. In this embodiment, the concentrate may include water, oil, and combinations thereof, and may include an emulsion of water and oil.

### (A) Active Component:

The active component is commonly known in the art as an “active ingredient.” In one non-limiting embodiment, the active component is further defined as a pesticide. In another embodiment, the active component is further described as an herbicide. In still another embodiment, the active component is further described as a fungicide. In even another embodiment, the active component is as described in U.S. Pat. No. 6,683,030 and/or U.S. Pat. App. Pub. No. 2006/0040828, each of which is expressly incorporated herein by reference.

The terminology “pesticide,” as used herein, is well known in the art and is described at least by the Environmental Protection Agency (EPA), in the Federal Insecticide, Fungicide, and Rodenticide Act (FIFRA), in the Insecticides and Environmental Pesticide Control Subchapter (7 U.S.C. §136(u)), in the Code of Federal Regulations (CFR) relating to the “Protection of Environment,” and in the Regulations of the EPA in 40 CFR § 152.3. A pesticide is typically recognized in the art as a substance that is used for preventing, destroying, repelling, regulating, and/or mitigating any pest. A pest is an organism that is deleterious to man or the environment but does not include any internal parasite of living man or other living animal or any fungus, bacterium, virus, or other microorganism on or in living man or other living animals. Said differently, the terminology “pest” does not typically include any organism that infects or sickens humans or animals. However, mosquito control and control of External Pests (such as stable flies) may be included herein. In addition, the terminology “pesticide,” as used herein, does not typically include any human or animal drugs or pharmaceuticals, any article that is a “new animal drug” as defined in the art, any liquid sterilant applied to a device used in the human body, and/or any products intended for use against fungi, bacteria, viruses, or other microorganisms in or on living man or living animal. Moreover, the pesticide of this invention does not typically include drugs or pharmaceuticals used to control diseases of humans or animals (such as livestock and pets).

In various non-limiting embodiments, the active component may be further defined as one or more of acaricides, avicides, algicides, biocides, fungicides, herbicides, insecticides, miticides, molluscicides, nematicides, ovicides, rodenticides, virucides, and combinations thereof. In another embodiment, the active component is selected from the group of fungicides, herbicides, insecticides, and combinations thereof.

In various additional embodiments, the active component includes, consists essentially of, or consists of, one or more herbicides, such as agricultural herbicides that can be applied to plants and or leaves of plants or weeds, fungicides, and/or insecticides, and the like. Typically, if the active component consists essentially of the herbicides, fungicides, and/or insecticides, the active component is free of compounds that materially affect the basic and novel characteristics of the active component such as those compounds which are not herbicides, fungicides, and/or insecticides.

The active component may also be, or alternatively may include, a pesticide as regulated by the EPA. Various non-limiting active components include acylalanines, acylamino acids, aliphatic amide organothiophosphate, aliphatic nitrogen, aliphatic organothiophosphates, amides, antiauxins, antibiotics, arylalanines, aryloxyphenoxypropionics, auxins, benzamides, benzanilides, benzimidazoles and precursors, benzimidazolylcarbamates, benzofuranyl alkylsulfonates, benzofuranyl methylcarbamate, benzoic acids, benzothiazoles, benzothiopyran organothiophosphates, benzotriazine organothiophosphates, benzoylcyclohexanediones, bipyridyliums, chitin synthesis inhibitors, chloroacetanilides, chloronicotinyl, chloropyridines, chlorotriazines, conazoles, copper, cyclic dithiocarbamates, cyclodienes, cyclohexene oximes, cyclopropylisoxazoles, cytokinins, diacylhydrazines, dichlorophenyl dicarboximides, dimethylcarbamates, dinitroanilines, diphenyl ethers, ethylene releasers, fluorine, furamides, furanilide, gibberellins, growth inhibitors, retardants, and stimulators, glufosinate, glyphosate, halogenated aliphatics, imidazoles, imidazolinones, insect growth regulators, isoindole organothiophosphate, isoxazole organothiophosphate, juvenile hormone and corresponding mimics, mercury, mite growth regulators, morphactins, morpholines, moulting hormones, agonists, and inhibitors, nereistoxins and corresponding analogues, nicotinoids, nitriles, nitroguanidines, nitromethylenes, organomercury, organothiophosphates, oxadiazines, oxathiin, oxazole, oxime organothiophosphate, phenoxys, phenoxyacetics, phenoxybutyrics, phenoxypropionics, phenyl ethylphosphonothioates, phenyl methylcarbamates, phenyl organothiophosphates, phenyl phenylphosphonothioates, phenylenediamines, phenyl pyrazolyl ketones, phenylureas, phosphonothioates, phosphoramidates, phosphoramidothioates, phosphorodiamides, phthalic acids, picolinic acids, polymeric dithiocarbamates, polysulfides, precocenes, pyrazoles, pyrazolopyrimidine organothiophosphate, pyrazolyloxyacetophenone, phenyl pyrazolyl ketones, pyrazolylphenyls, pyrethroids, pyrethroid esters, pyridazines, pyridazinones, pyridylmethylamines, pyrimidinamines, pyrimidines, pyrimidine organothiophosphates, pyrimidinediamines, pyrimidinyloxybenzoic acids, pyrimidinylsulfonylureas, pyrimidinylthiobenzoic acids, quaternary ammoniums, quinolines, quinolinecarboxylic acids, quinones, quinoxalines, strobilurins, sulfite esters, sulfonamides, sulfonanilides, sulfonylureas, tetrazines, tetronic acids, thiadiazole organothiophosphates, thiadiazolylureas, thioamides, thiazoles, thiocarbamates, thiocarbonates, thiophenes, thioureas, triazines, triazinones, triazinylsulfonylureas, triazoles, triazole organothiophosphates, triazolones, triazolopyrimidines, uracils, ureas, valinamides, xylylalanines, combinations thereof, and salts thereof including but not limited to, alkaline and alkaline earth metal salts, trimesium salts, ammonium salts, isopropylamine salts, and combinations thereof. In the alternative, the composition as a whole may include one or more of the aforementioned compounds or combinations thereof. In yet another embodiment, the active component is selected from the group of glufosinate, glyphosate, and combinations thereof. Alternatively, the active component may be glufosinate or glyphosate.

The active component and or the composition as a whole may also include additional chemical compounds that are not pesticides or active ingredients. Examples include, but are not limited to, activators, anti-feedants, anti-fouling agents, attractant agents, chemosterilants, disinfectant agents, fumigant agents, pheromones, repellent agents, defoliants, desiccants, insect growth regulators, plant growth regulators, synergists, adjuvants, and combinations thereof.

The active component is typically in the composition in amounts of from about 0.00001 weight percent to about 90 weight percent, based on a total weight of the composition. In other embodiments, the active component is present in amounts of from about 0.00001 to about 10, 0.00001 to about 9, about 0.00001 to about 8, about 0.00001 to about 7, about 0.00001 to about 6, about 0.00001 to about 5, 0.00001 to about 4, about 0.00001 to about 3, about 0.00001 to about 2, about 0.00001 to about 1, about 1 to about 9, about 2 to about 8, about 3 to about 7, about 4 to about 6, or about 5 to about 6, weight percent based on a total weight of the composition. In further embodiments, the active component is present in the composition in an amount of from 1 to 99, of from 3 to 7, or of about 5, parts by weight per 100 parts by weight of the composition. In still other embodiments, the active component is present in an amount (or in an amount equivalent to) from 100 to 1000, from 200 to 900, from 300 to 800, from 400 to 700, from 500 to 600, or about 400, grams of active component per hectare. It is also contemplated that the active component may alternatively be present in one or more of the amounts set forth below as described relative to polyethyleneimine.

### (B) Polyethyleneimine:

The composition also includes polyethyleneimine (PEI) having a weight average molecular weight (M_{w}) of at least about 750,000 g/mol. In various embodiments, the PEI is further defined as having a weight average molecular weight of from about 750,000 to about 3,000,000, of from about 750,000 to about 2,000,000, of from about 750,000 to about 1,000,000, of from about 1,000,000 to 1,500,000, of from about 1,500,000 to about 2,000,000, of from about 1,000,000 to about 2,000,000, g/mol. In other embodiments, the PEI has a weight average molecular weight of from about 2,000,000 to about 8,000,000, of from about 3,000,000 to about 7,000,000, of from about 4,000,000 to about 6,000,000, of from about 4,000,000 to about 5,000,000, g/mol. The PEI of this invention is typically cationic and may be exempted pursuant to 40 CFR §§180.910, 180.920, 180.930, and/or 180.940 and may or may not be exempted pursuant to 40 CFR §§180.950 and/or 180.960.

In various other embodiments, the PEI has the following formula:

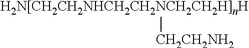

wherein n is about 4,500 to about 50,000 such that the PEI has a weight average molecular weight of about 750,000 to about 8,000,000, g/mol. It is also contemplated that the PEI may have any value or range of values, both whole and fractional, within those ranges described above. In still other embodiments, the PEI has the following structure:

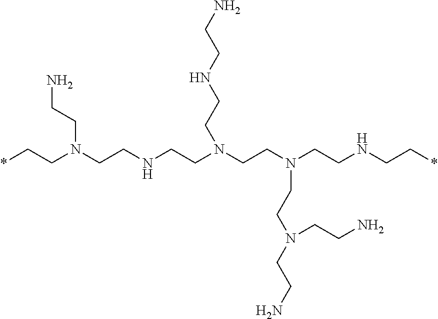 [SMILES: *CCNCCN(CCN(CCN)CCN)CCN(CCNCCN)CCNCCN(CC*)CCN]

In various embodiments, the PEI may have one or more of the following physical characteristics and may be mixed with water. However, it is contemplated that the PEI may have different physical characteristics or not have any of the following characteristics.

| | Non-Limiting | Non-Limiting | Non-Limiting |
|---|---|---|---|
| Physical | Embodiment 1 | Embodiment 2 | Embodiment 3 |
| Characteristics | of PEI | of PEI | of PEI |
| Appearance | Liquid | Liquid | Liquid |
| Approx. Viscosity at | 1,400 | 750 | 500 |
| 20° C. (mPAs) | | | |
| Approx. Concentration | 33 | 24 | 24 |
| in Water (wt %) | | | |
| Approx. Water | 67 | 76 | 76 |
| Content (wt %) | | | |
| Approx. Pour Point | −5 | 0 | 0 |
| (° C.) | | | |
| Approx. Boiling Point | 100 | 100 | 100 |
| (° C.) | | | |
| Approx. Flame Point | >100 | >100 | >100 |
| (° C.) | | | |
| Approx. Density at | 1.06 | 1.06 | 1.06 |
| 20° C. (g/cm³) | | | |
| Approx. pH value | 11 | 8.3 | 8.3 |
| (1% in Water) | | | |
| Approx. pKa Value | 7-10 | 7-10 | 7-10 |
| Approx. Charge | 20 | 8 | 9.5 |
| Density | | | |
| Approx. Weight | 750,000 | 2,000,000 | 1,000,000 |
| Average Molecular | | | |
| Weight (M_{w}) (g/mol) | | | |
| Approx. Ratio of | 1:1.07:0.77 | — | — |
| 1°:2°:3° Amines | | | |

In various embodiments, the PEI is commercially available from BASF Corporation under the trade names of Lupasol® P, Lupasol® PS, Lupasol® SK, and Lupasol® SNA.

The PEI is typically present in the composition in amounts of from about 0.0001 weight percent to about 5 weight percent, based on a total weight of the composition. In other embodiments, the PEI is present in amounts of from about 0.0001 to about 4, about 0.0001 to about 3, about 0.0001 to about 2, about 0.0001 to about 1, about 0.001 to about 5, about 0.001 to about 4, about 0.001 to about 3, about 0.001 to about 2, about 0.001 to about 1, about 0.01 to about 5, about 0.01 to about 4, about 0.01 to about 3, about 0.01 to about 2, about 0.01 to about 1, 0.1 to about 5, about 0.1 to about 4, about 0.1 to about 3, about 0.1 to about 2, about 0.1 to about 1, 0.0001 to about 0.1, about 0.0001 to about 0.01, about 0.0001 to about 0.001, about 0.001 to about 0.1, about 0.001 to about 0.01, weight percent based on a total weight of the composition.

The PEI is not particularly limited relative to a method of forming and may be formed using any method known in the art. Most typically, the PEI is formed via polymerizing ethyleneimine monomers. However, the PEI is not limited to formation in such a way. In one embodiment, the PEI is formed using a method such that a mixture of PEI and a solvent (such as water) is produced. Alternatively, PEI and a solvent may be combined. In various non-limiting embodiments, the PEI is provided as a mixture in water wherein the PEI is present in the water in an amount of from 20 to 50, 25 to 45, 30 to 40, or 35 to 40, weight percent based on a total weight of the water. In alternative embodiment, the PEI is present in the water in amount of about 24 or 33 weight percent based on a total weight of the water.

### (C) Water:

In addition to the active component and the PEI, the composition may also include water. This water may be the same as, or independent from, the water described immediately above as optionally mixed with the PEI. For example, the active component may be combined with the PEI wherein the PEI is already present in water. This combination may then be further combined with additional water. The water present with the PEI and/or the additional water may be of any type and purity including, but not limited to, tap water, well water, and the like. Water is not particularly limited relative to a total amount of the composition. In various embodiments, water is present in the composition in amounts of from 1 to 99, 5 to 95, 10 to 90, 15 to 85, 20 to 80, 25 to 75, 30 to 70, 35 to 65, 40 to 60, 45 to 55, or 45 to 50, weight percent based on a total weight of the composition. Water may be added to the active component and/or the PEI independently or together. In addition, all ranges and subranges, both whole and fractional, between those ranges described above are herein contemplated as non-limiting options for this invention.

In still other embodiments, the active component is diluted with water and is present in the composition in an amount of at least 1 part by weight per 100 parts by weight of the composition. In another embodiment, the active component is diluted with water and present in an amount of from 1 to 10, even more typically of from 3 to 7, and most typically of 5, parts by weight per 100 parts by weight of the composition. In still another embodiment, the active component is not diluted with water. It is to be appreciated that one skilled in the art will choose whether to mix the active component with water, depending on application.

### Additional Optional Additives and Components:

The composition may also include an additive or more than one additive. The additive or more than one additive may be as described in one of more of 40 CFR §§180.910, 180.920, 180.930, 180.940, 180.950, 180.960, and/or in the individually listed exemptions set forth therein. In other embodiments, the additive or more than one additive may be selected from the group of a water soluble amine, alcohol, and combinations thereof. One or a plurality of additives may be utilized in the present invention, and the additive may be present in the composition in any amount. In one embodiment, the additive includes the water soluble amine. Any water soluble amine known in the art may be used in the present invention. Typically, the water soluble amine includes, but is not limited to, aromatic and cyclo-aliphatic amines including alkanol amines, methylamine, dimethylamine, trimethylamine, ethylamine, diethylamine, triethylamine, n-propylamine, di-n-propylamine, tri-n-propylamine, isopropylamine, n-butylamine, isobutylamine, secondary butylamine, tertiary butylamine, cyclohexylamine, benzylamine, alpha-phenylethylamine, beta-phenylethylamine, ethylenediamine, tetramethylenediamine, hexamethylenediamine, tetramethylammonium hydroxide, morpholine, N-methyl morpholine, N-ethyl morpholine, dimethylaminopropylamine, N,N-dimethylethanolamine, alpha- and gammapicoline, piperazine, isopropylaminoethanol, N,N-dimethylcyclohexylamine, 2-amino-2-methyl-1-propanol, and combinations thereof.

In another embodiment of the present invention, the additive includes an alcohol. Typically, the alcohol includes propylene glycol. However, any alcohol known in the art may be used.

Other additives that may be present in the composition include, but are not limited to, spreading agents, wetting agents, building agents, extending agents, emulsifiers, dispersants, suspending agents, plant penetrants, translocators, oils, activators, foliar nutrients, compatibility agents, drift retardants, foam retardants, buffers, inverting agents, soil penetrants, stabilizing agents, UV filters, feeding stimulants, washing agents, sinking agents, binders, liquid carriers, dry carriers such as attapulgite, kaolinite, vermiculite, starch polymers, corn cob, and combinations thereof. The other additives may be present in the composition in any amount.

The composition may also include a surfactant. Surfactants typically modify surface properties of the composition. Typically the surfactant contributes to efficacy of the composition through increased activity and increased damage to the pest. The surfactant may be any surfactant known in the art, including, but not limited to, anionic, cationic, amphoteric, and non-ionic surfactants, carboxylic acid surfactants, sulfate surfactants, sulfonic acid surfactants, phosphate surfactants, polyoxyalkylene polyol surfactants, alkylphenol ethoxylate surfactants, and combinations thereof. Other suitable surfactants include, but are not limited to, copolymers of acrylic acid and vinyl acetate, copolymers of acrylic acid and maleic acid, N-methyl-(C₁₂-C₁₈) fatty acid sarcosinates, resin acids, (C₁₂-C₁₈) fatty acids, salts of the carboxylic acids, and combinations thereof. Suitable sulfate surfactants include, but are not limited to, (C₁₂-C₁₈) alkyl sulfates, polyoxyethylene (C₁₂-C₁₈) alkyl ether sulfates, polyoxyethylene (mono or di) (C₈-C₁₂) alkylphenyl ether sulfates, sulfates of polymers of polyoxyethylene (mono or di) (C₈-C₁₂) alkyliphenyl ethers, polyoxyethylene (mono, di or tri)phenylphenyl ether sulfates, polyoxyethylene (mono, di or tri)benzylphenyl ether sulfates, polyoxyethylene (mono, di or tri)styrylphenyl ether sulfates, sulfates of polymers of polyoxyethylene (mono, di or tri)styxylphenyl ethers, sulfates of polyoxyethylene-polyoxypropylene block polymers, sulfated oils, sulfated fatty acid esters, sulfated fatty acids, sulfated olefins, salts of the sulfate surfactants, and combinations thereof. Suitable sulfonic acid surfactants include, but are not limited to, (C₁₂-C₂₂) paraffinsulfonic acids, (C₈-C₁₂) alkylbentenesulfonic acids, formalin condensates with (C₈-C₁₂) alkylbenzenesulfonic acids, formalin condensates with cresolsulfonic acids, (C₁₄-C₁₆) a-olefmsulfonic acids, (C₈-C₁₂) dialkyl sulfosuccinic acids, lignin sulfonic acids, polyoxyethylene (mono or di) (C₈-C₁₂) alkylphenyl ether sulfonic acids, half esters of polyoxyethylene (C₈-C₁₂) alkyl ether sulfosuccinic acids, naphthalenesulfonic acids, (mono or di) (C₁-C₆) alkylnaphthalenesulfonic acids, formalin condensates with naphthalenesulfonic acids, formalin condensates with (mono or di) (C₁-C₆) alkylnaphthalenesulfonic acids, formalin condensates with creosote oil sulfonic acids, (C₈-C₁₂) alkyldiphenyl ether disulfonic acids, Igepon T, polystyrenesulfonic acids, copolymers of styrenesulfonic acid and methacrylic acid, salts of the sulfonic acid surfactants, and combinations thereof. Examples of suitable phosphate surfactants include, but are not limited to, (C₈-C₁₂) alkyl phosphates, polyoxyethylene (C₁₂-C₁₈) alkyl ether phosphates, polyoxyethylene (mono or di) (C₈-C₁₂) alkylphenyl ether phosphates, phosphates of polymers of polyoxyethylene (mono, di or tri) (C₈-C₁₂) alkylphenyl ethers, polyoxyethylene (mono, di or tri)phenylphenyl ether phosphates, polyoxyethylene (mono, di or tri)benzylphenyl ether phosphates, polyoxyethylene (mono, di or tri)styrylphenyl ether phosphates, phosphates of polymers of polyoxyethylene (mono, di or tri)styrylphenyl ethers, phosphates of polyoxyethylene-polyoxypropylene block polymers, phosphatidyl cholines, phosphatidyl ethanolimines, polyphosphates (e.g., tripolyphosphate, etc.), salts of the phosphate surfactants, and combinations thereof. Suitable examples of the polyoxyalkylene polyol surfactants, include, but are not limited to Pluronic® polyethers and Tetronic® polyethers, commercially available from BASF Corporation of Wyandotte, Mich. Suitable examples of the alkylphenol ethoxylate surfactants include, but are not limited to, Iconol® and Lutensol® surfactants, commercially available from BASF Corporation. Specifically, salts of the carboxylic acid, sulfonic, sulfate, phosphate, and polyoxyalkylene, and alkylphenol ethoxylate surfactants, include, but are not limited to, alkaline and alkaline earth metal salts, ammonium and amine salts, and combinations thereof. If the composition includes the surfactant, the surfactant is typically included in an amount of from 0.01 to 10, more typically of from 0.01 to 8, and most typically of from 0.3 to 3, parts by weight per 100 parts by weight of the composition. It is also contemplated that the instant invention may include one or more components as described in PCT/US2011/027151 filed on Mar. 4, 2011 and/or in U.S. Pat. App. Pub. No. 2006/0040828, each of which is expressly incorporated herein by reference.

### Rainfastness:

The composition typically has excellent rain fastness. Most typically, the composition, once sprayed onto the target, is not easily rinsed off of the target with rain or irrigation. Without intending to be bound by any particular theory, it is believed that if the composition is sprayed onto plants, the composition forms a film, binds to leaves of the plant, and resists being rinsed off of the leaves of the plant.

The degree or quality of rainfastness may be evaluated qualitatively or quantitatively. For example, rainfastness may be deemed to be excellent if the composition only needs to remain on or in contact with a target for 5, 15, 30, 45, or 60 minutes or for 2, 3, 4, 5, or 6, hours (depending on heat and humidity, as selected by one of skill in the art) before rain, water, or irrigation is applied to the target and that, based on that time, the composition remains able to achieve the desired result (e.g. killing of plants, insects, fungi, etc).

Alternatively, rainfastness may be described as a weight percentage of the active component remaining on the target after specified conditions. For example, greater than 1, 5, 10, 20, 30, 40, 50, 60, 70 80, 90, 95, or 99, weight percent of the active component may remain on the target after 15, 30, 45, or 60 minutes or 2, 3, 4, 5, or 6, hours and also after application of water (depending on heat and humidity, as selected by one of skill in the art). In other embodiments, the composition has a rainfastness of greater than 10, more typically of from 20 to 100, and most typically of from 40 to 80, percent at commercial spray conditions well known to those in the art. Those of skill in the art appreciate that differing applications, active components, and desired results require differing rainfastness and differing weight percents of the active component to remain on the target per given time and irrigation conditions.

### Method of Forming the Pesticide Composition:

This invention also provides a method of forming the composition. The method includes the steps of providing the (A) active component, providing the (B) polyethyleneimine, and combining (A) and (B) to form the composition. In one embodiment, the composition further includes (C) water and the step of combining is further defined as combining (A), (B), and (C) to form the composition. (A) and (C) may be combined prior to combination with (B). Alternatively, (A) and (B) may be combined prior to combination with (C). It is also contemplated that (B) and (C) may be combined prior to combination with (A). Additionally, (A), (B), and (C) may be combined simultaneously. In one embodiment, (A), (B), and (C) are combined in a spray tank, as appreciated in the art. In this embodiment, (A) and (B) may be in a concentrate or concentrated form and the (C) water may be added in the spray tank before application to the target. In another embodiment, the method further includes the step of adding an additional amount of water to the combination of (A), (B), and (C) in a spray tank. In this embodiment, the composition already includes an amount of water before the composition is prepared for application to the target. It is contemplated that, in the spray tank prior to application to the target, additional water may be added to dilute (A), (B), and (C). In various embodiments, the composition is diluted with one or more amounts of water such that the composition could be used at a spray rate/amount of 7, 8, 9, 10, 15, or 20+ gallons per acre of land, as is appreciated in the art.

### Method of Applying the Pesticide Composition:

The composition may be applied to a target by any means known in the art including spraying, pouring, misting, as an aerosol, as a liquid, as a gel, as an emulsion, etc. Typically, the pesticide composition is applied to the target by spraying through a nozzle of a spray applicator. One skilled in the art will select an appropriate nozzle based on need and application.

The pesticide composition, if sprayed, typically forms droplets. Typically, the droplets have a diameter of from 5 to 1,500, more typically of from 100 to 1,400, and most typically of from 200 to 1,300, microns. The diameter of the droplets allows the pesticide composition to be applied while reducing a tendency of the pesticide composition to be subject to wind-drift.

The composition, including (A) and (B), may be applied to the target directly without dilution or may be diluted with (C) water, as described above. The dilution with (C) water may occur prior to sale during manufacturing such that the (C) water is part of a concentrate or original formulation. Alternatively, the dilution with (C) water may occur on location prior to application of the composition to the target. For example, the composition may be diluted with (C) water in a spray tank in an agricultural location prior to spraying the composition on the agricultural target, e.g., crops or weeds.

The composition may be applied to one or more targets in a variety of conditions. For example, the composition may be applied to weeds or plants subject to no rain, rain after 1 hour, 2 hours, 3 hours, 4 hours, 5 hours, or 6 hours at any level of humidity. The amount of rain is not particularly limited and may be equivalent to 0.1, 0.25, 0.5, 0.7, or 1 inch of rain, or even more, e.g. in accordance with the procedure described in the Examples below. The composition may produce a kill rate of greater than or equal to about 5, 10, 15, 20, 25, 30, 35, 40, 45, 50, 55, 60, 65, 70, 75, 80, 85, 90, or 95 percent, as determined using one or methods described in the Examples below.

In various embodiments, the composition produces a kill rate of greater than about 35% or about 40% measured 14 or 28 days after application of the composition to forage barley plants rinsed with one-half inch of rain one hour after application of the composition. In other embodiments, the composition produces a kill rate of greater than about 35% or 40% measured 14 or 28 days after application of the composition to forage barley plants rinsed with one-half inch of rain one hour after application of the composition and again rinsed with an additional one-half inch of rain two hours after application of the composition.

### EXAMPLES

A series of compositions, Compositions 1-3, are formulated that include a polyethyleneimine of this invention. A series of comparative compositions, Comparative Compositions 1 and 2, are also formulated. Comparative Composition 1 is a control composition and does not include any polyethyleneimine whatsoever. Comparative Composition 2 includes a polyethyleneimine that has a low molecular weight and that is not representative of this invention.

Compositions 1-3 and Comparative Composition 2 are formulated by dissolving amounts of various polyethyleneimines in 100 mL of deionized water, as set forth below. 0.1 grams of fluroescein is then added to each composition such that each Composition has a 1000 ppm concentration of fluroescein. Comparative Composition 1 is formulated by forming a 1000 ppm solution of fluroescein without any polyethyleneimine. The only differences between the Compositions and Comparative Compositions is the polyethyleneimine. The components used to form each Composition are set forth below.

TABLE 1

| | | | | Comparative | Comparative |
|---|---|---|---|---|---|
| | Composition 1 | Composition 2 | Composition 3 | Composition 1 | Composition 2 |
| Polymer 1 | 0.42 | — | — | — | — |
| Polymer 2 | — | 0.30 | — | — | — |
| Polymer 3 | — | — | 0.20 | — | — |
| Comparative | — | — | — | — | 0.10 |
| Polymer 1 | | | | | |
| Fluroescein | 0.1 grams | 0.1 grams | 0.1 grams | 0.1 grams | 0.1 grams |
| DI Water | 100 mL | 100 mL | 100 mL | 100 mL | 100 mL |

Polymer 1 is Lupasol ® SK which is commercially available from BASF
Corporation. Lupasol ® SK has a weight average molecular weight of about 2,000,000 g/mol.
Polymer 2 is Lupasol ® PS which is commercially available from BASF
Corporation. Lupasol ® PS has a weight average molecular weight of about 750,000 g/mol.
Polymer 3 is Lupasol ® P which is commercially available from BASF
Corporation. Lupasol ® P has a weight average molecular weight of about 750,000 g/mol.
Comparative Polymer 1 is Lupasol ® G20 which is commercially available from BASF Corporation. Lupasol ® G20 has a weight average molecular weight of about 1,300 g/mol.

After formation, about 0.25 grams of each of the Compositions and Comparative Compositions are applied to individual 3″×6″ aluminum panels covered with Parafilm. More specifically, the panels are wrapped with Parafilm and zeroed on an analytical scale. After zeroing, the about 0.25 grams of each of the Compositions are sprayed onto the panels with an air brush gun. The weights of the total amounts of the Compositions sprayed onto the panels are then recorded. The Compositions are then allowed to dry overnight at room temperature.

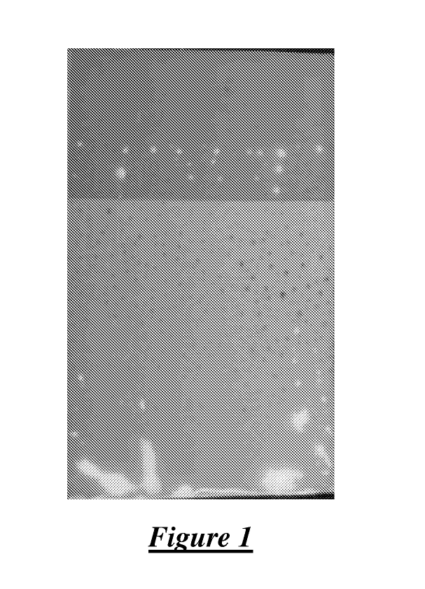

After the Compositions are dried overnight, three 2″×3″ inch strips of the Parafilm are cut from the panels. Each strip is then dipped into a beaker having ˜250 ml of water therein. Each strip is gently submerged in the water for 1-2 seconds and then removed. Each strip is then immediately put under a UV-lamp and an image is captured with a digital camera. These images are set forth as FIGS. 1-5. This process is repeated using new water for each strip.

FIG. 1 is a photographic image of the strip including Composition 1 disposed thereon. As shown in the image, much of Composition 1 remains on the strip after submersion in water. When compared to the images from Comparative Compositions 1 and 2, it is clear that the polyethyleneimine of this invention outperforms the comparative examples.

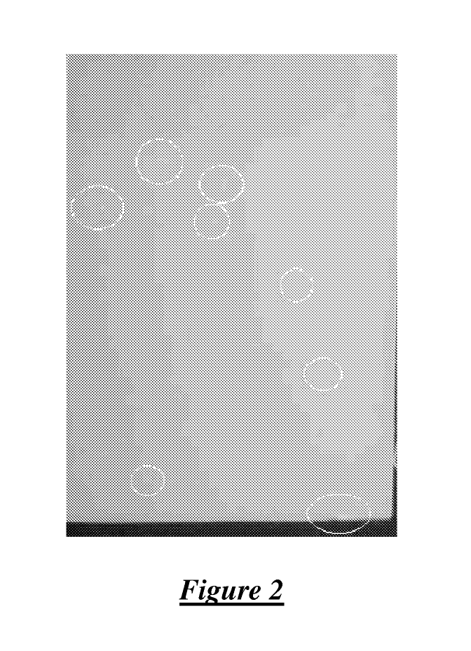

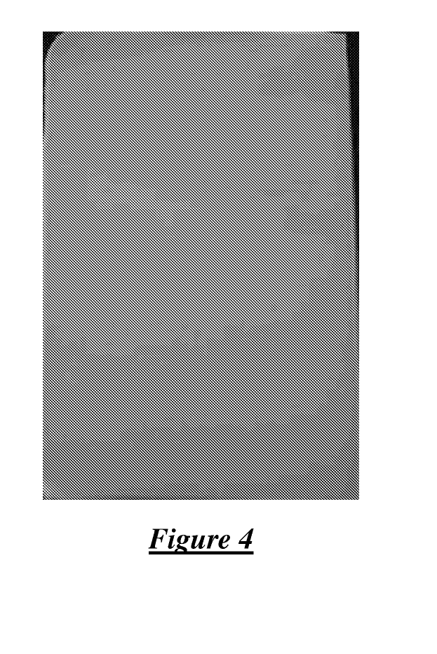

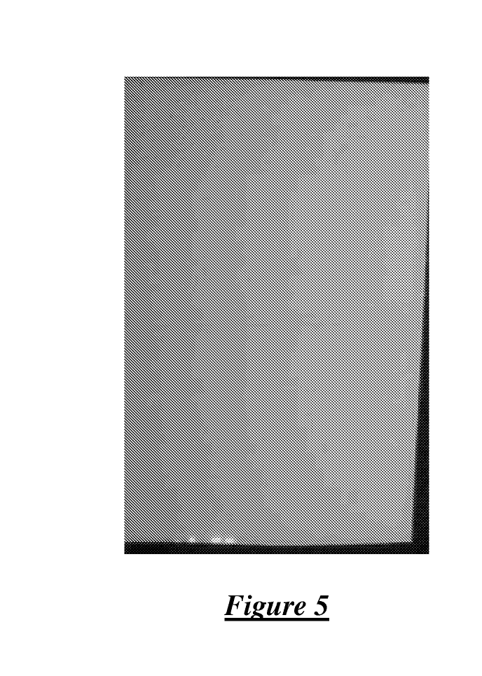

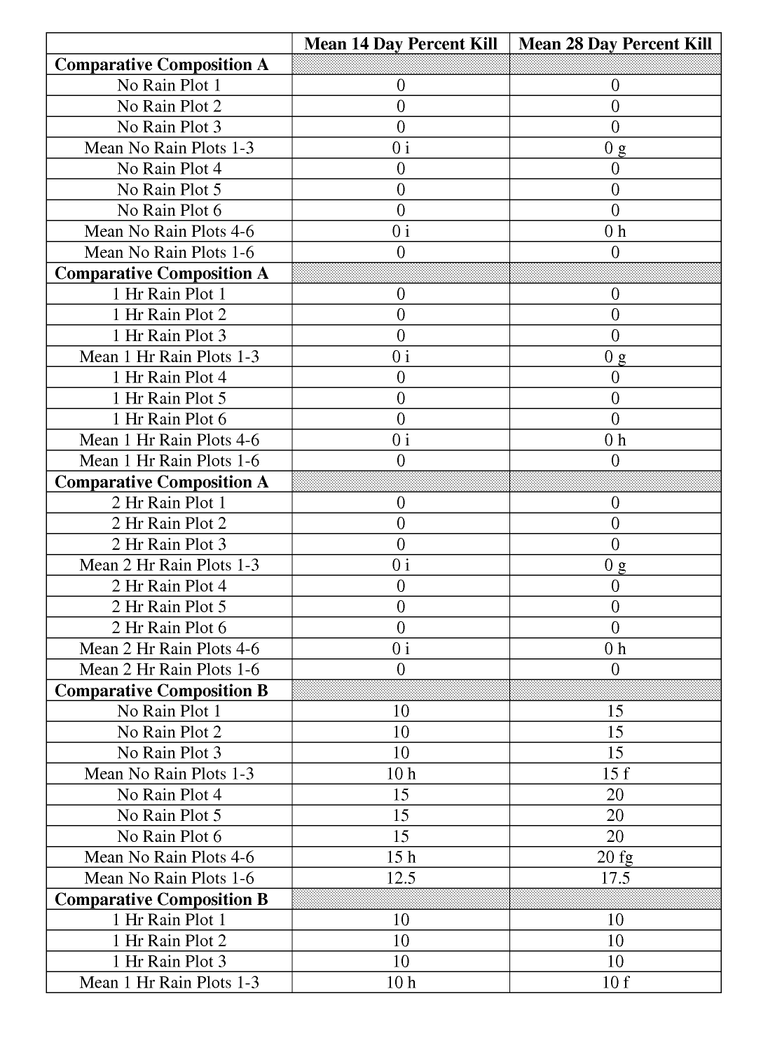

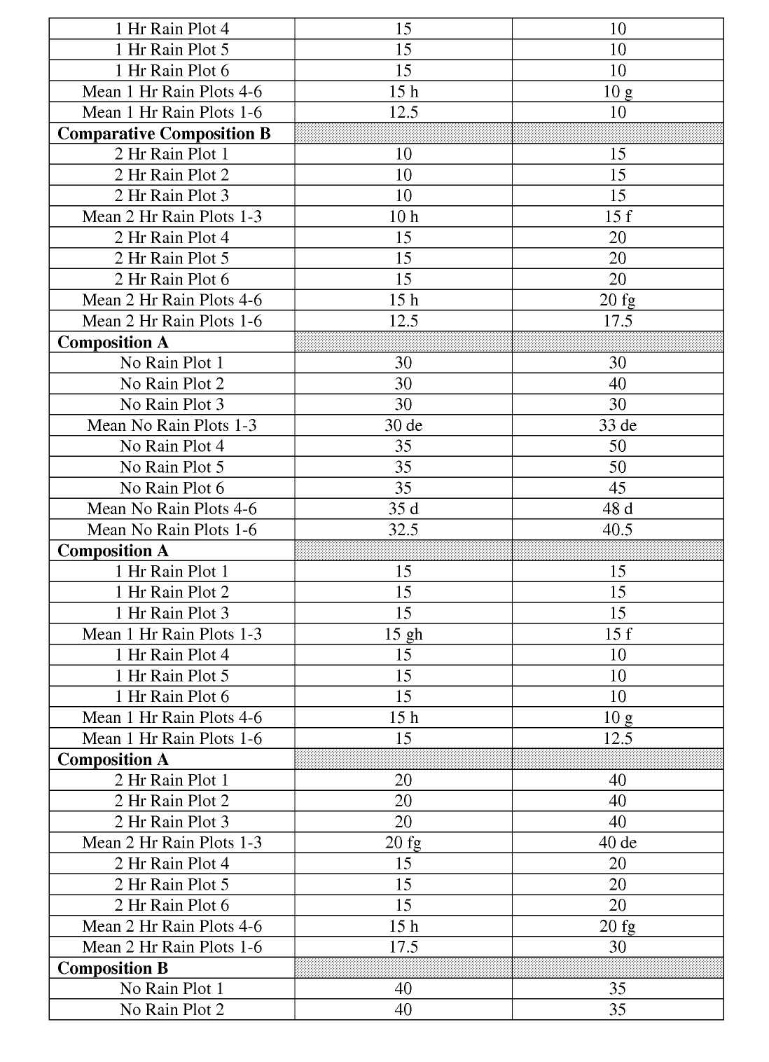

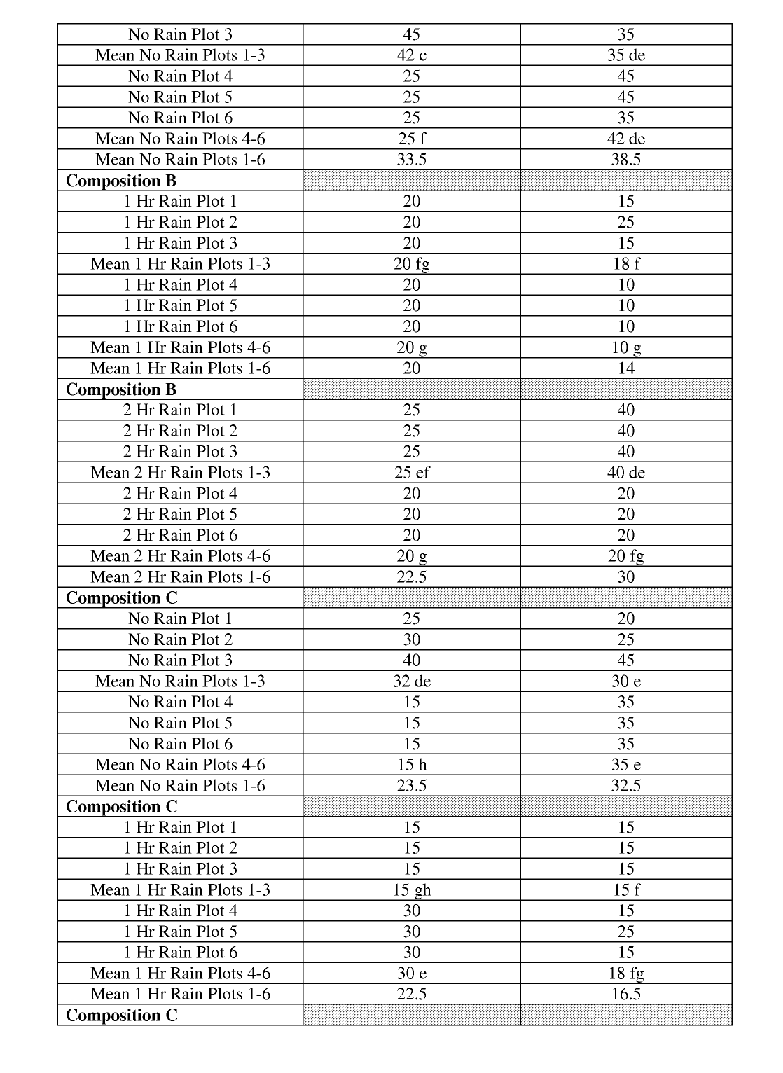

FIG. 2 is a photographic image of the strip including Composition 2 disposed thereon. As shown in the image, portions of Composition 2 remain on the strip after submersion in water. FIG. 2 is annotated with ovals to highlight large sections of remaining fluorescence. FIG. 2 also includes a plurality of fine droplets of Composition 2 dispersed across a surface of the Parafilm strip (not annotated) which fluoresce to lighten most of the entire strip. Notably, the entire strip in FIG. 2 is lighter in color/shade as compared to the strips that include the Comparative Compositions described below (see FIGS. 4 and 5). This suggests that much of the entire strip includes droplets of Composition 2 disposed thereon. This data further suggests that the polyethyleneimine of this invention outperforms the comparative examples when compared to the images from Comparative Compositions 1 and 2.

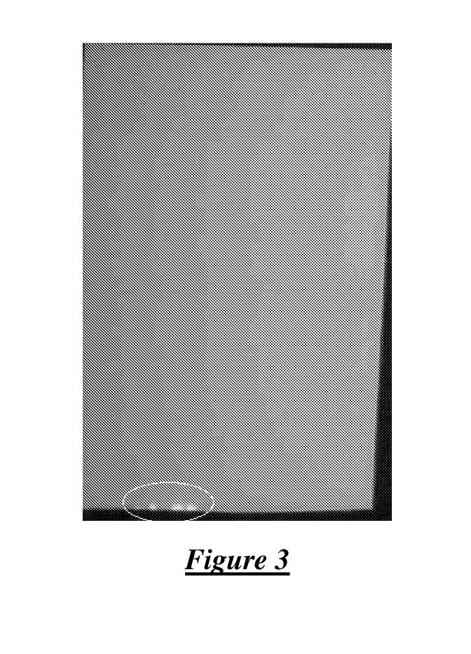

FIG. 3 is a photographic image of the strip including Composition 3 disposed thereon. As shown in the image, portions of Composition 3 remain on the strip after submersion in water. This data further suggests that the polyethyleneimine of this invention outperforms the comparative examples when compared to the images from Comparative Compositions 1.

FIG. 4 is a photographic image of the strip including Comparative Composition 1 disposed thereon. As shown in the image, there is no fluorescence on this strip indicating that all of the fluroescein is washed off. When compared to the images of Compositions 1-3, it is clear that Compositions 1-3 produce superior results.

FIG. 5 is a photographic image of the strip including Comparative Composition 2 disposed thereon. As shown in the image, there is almost no fluorescence on this strip indicating that almost of the fluroescein is washed off. When compared to the images of Compositions 1-3, this data further suggests that Compositions 1-3 outperform the Comparative Compositions.

As shown in the images and Figures described above, it is clear that the Compositions of this invention outperform the comparative examples. This data surprisingly shows that the polyethyleneimines having higher weight average molecular weights impart increased rainfastness to compositions.

### Field Testing Data:

A series of pesticide compositions (Compositions A, B, and C) are formed according to this invention. Two comparative compositions (Comparative Compositions A and B) are also formed but not according to this invention.

Composition A includes 1000 ppm of Lupasol® SK in water and 400 grams of Glyphosate per hectare as a dissociated salt, as understood by those of skill in the art.

Composition B includes 500 ppm of Lupasol® SK in water and 400 grams of Glyphosate per hectare as a dissociated salt, as understood by those of skill in the art

Composition C includes 250 ppm of Lupasol® SK in water and 400 grams of Glyphosate per hectare as a dissociated salt, as understood by those of skill in the art

Comparative Composition A includes only water and no glyphosate.

Comparative Composition B includes 400 grams of Glyphosate per hectare as a dissociated salt, as understood by those of skill in the art.

The Glyphosate described above is commercially available from Sygenta under the trade name of Touchdown HiTech®.

### Forage Barley Examples:

After formation of the Compositions A-C and Comparative Compositions A and B, thirty groups of forage barley plants are segregated for testing. For purposes of these examples, the barley plants are considered undesirable weeds. Each of the thirty groups includes three independent plots of the forage barley plants. Samples of each of the Compositions A-C and Comparative Compositions A and B are sprayed onto various plots of the barley plants. The groups are first (1) sprayed with various compositions, then (2) subjected to no rain after application of the Compositions, approximately ½ inch of rain after 1 hour subsequent to application of the Compositions, or approximately ½ inch of rain after both 1 and again after 2 hours, subsequent to application of the Composition. Then, the groups are (3) evaluated after 14 days and again after 28 days to determine a percentage of plants killed based on application of the Compositions. The Compositions are applied under conditions known in the art at a rate of about 10 gallons per acre, at a temperature of about 66° F., at a relative humidity of about 54%, and through a nozzle at a pressure of about 40 psi.

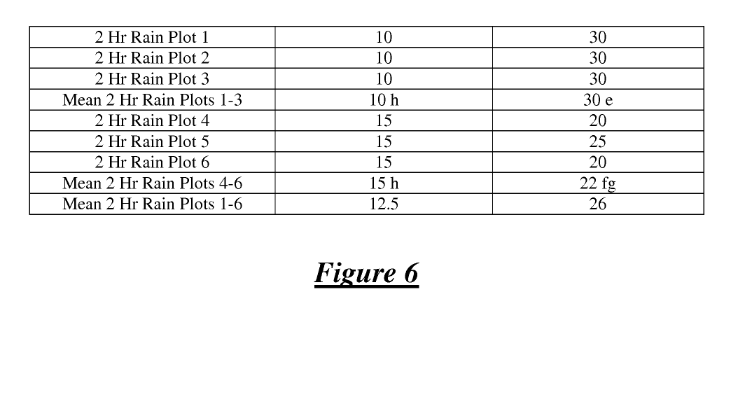

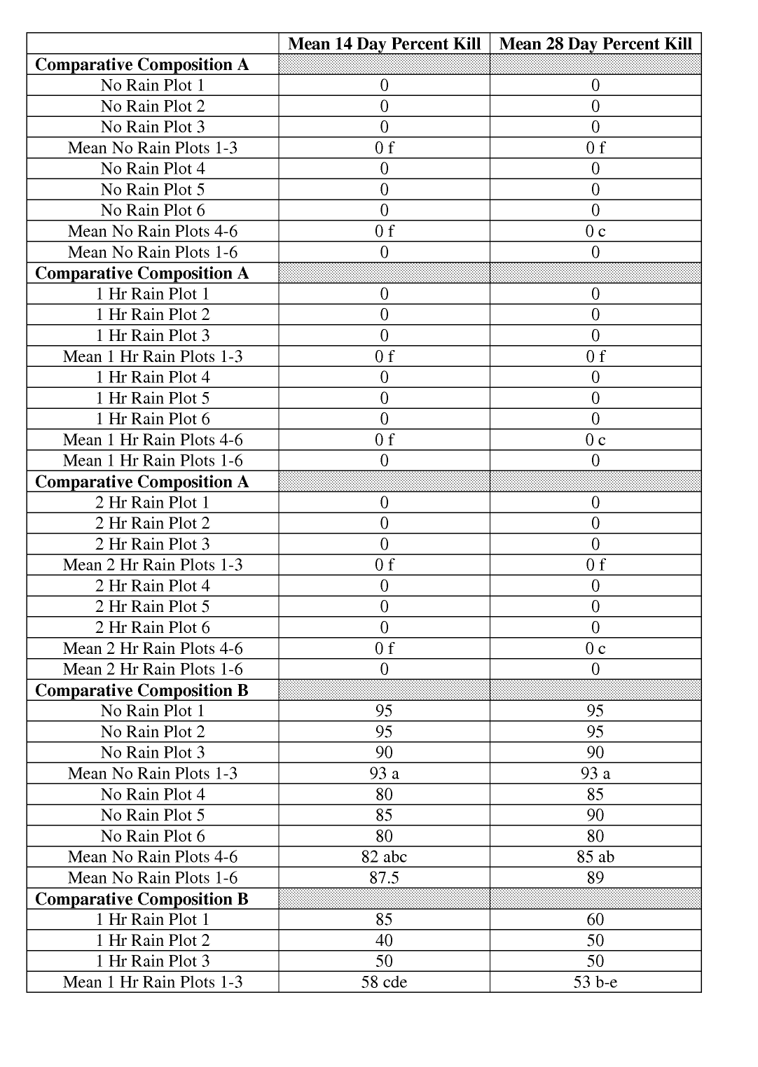

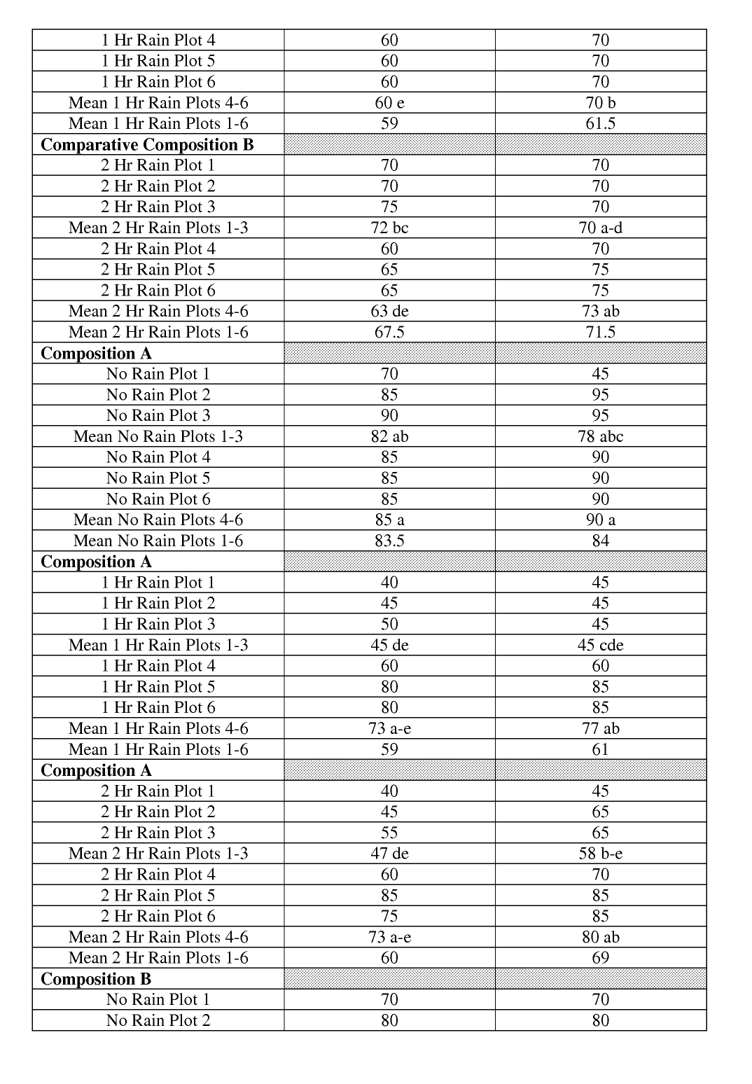

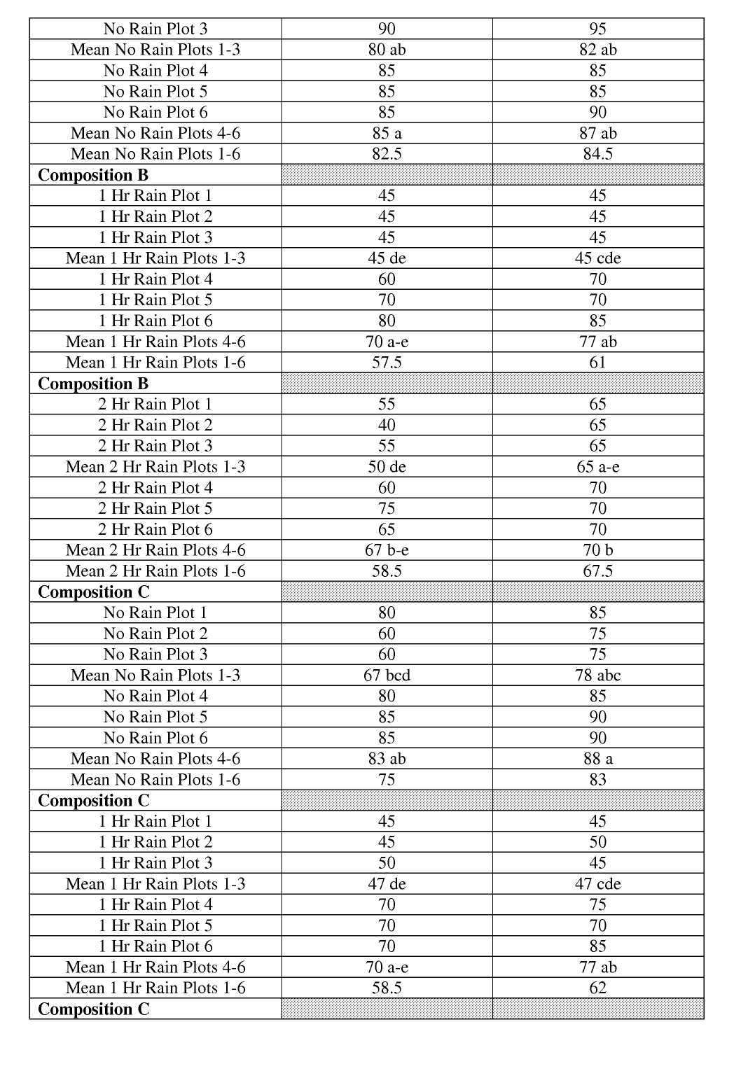

The mean percent kill of each group and each plot is set forth in FIG. 6 along with letters from Duncan's New Multiple Range Test (MRT) which, as known in the art, represent relationships between the data and significance of the data.

As is well known in the art, Duncan's new multiple range test (MRT) is a multiple comparison belongs to the general class of multiple comparison procedures that use the studentized range statistic qr to compare sets of means. More specifically, Duncan's MRT is a variant of the Student-Newman-Keuls method that uses increasing alpha levels to calculate the critical values in each step of the Newman-Keuls procedure. Duncan's MRT attempts to control family wise error rate (FWE) at α_{ew}=1-(1-α_{pc})^{k-1} when comparing k, where k is the number of groups. This results in higher FWE than unmodified Newman-Keuls procedure which has FWE of α_{ew}=1-(1-α_{pc})^{k/2}. Without intending to be bound by any particular theory, it is believed that Duncan's MRT is especially protective against false negative (Type II) error at the expense of having a greater risk of making false positive (Type I) errors. Duncan's test is commonly used in agronomy and other agricultural research. As is also well known in the art, if the aforementioned data is statistically the same, then the data will share the same letter, e.g. a, b, c, etc. If the data is significantly different, the data will have different letters. If data includes multiple letters, e.g. d, e, f, then the data is not significantly different from other data that shares any of the multiple letters. As just one example, data that is followed by d, e, and f″ is not significantly different from other data that is followed by d, e, or f. As is appreciated in the art, this system is a convenient way for biologists to sort differences between data and is a favored evaluation system to evaluate plants for efficacy of herbicides, insecticides and fungicides within the agricultural arts.

### Additional Examples

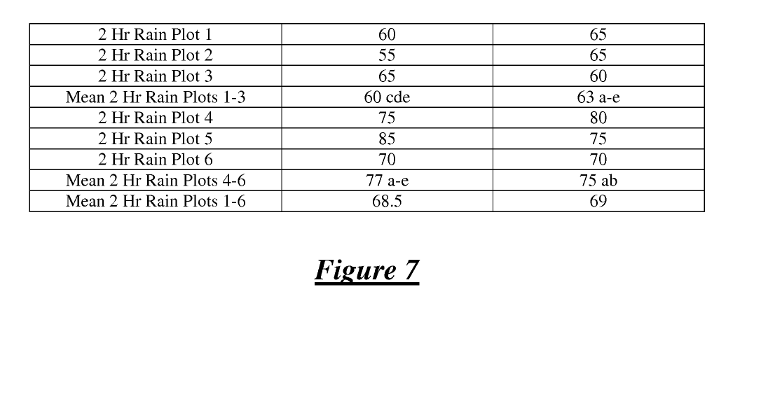

Thirty additional groups of barley plants are segregated. For purposes of these examples, the barley plants are considered undesirable weeds. Each of these thirty groups also includes three independent plots of the barley plants. Samples of each of the Compositions A-C and Comparative Compositions A and B are sprayed onto various plots of the Barley plants. Just as above, the groups are first (1) sprayed with various compositions, then (2) subjected to no rain after application of the Compositions, approximately ½ inch of rain after 1 hour subsequent to application of the Compositions, or approximately ½ inch of rain after both 1 and again after 2 hours, subsequent to application of the Composition. Then, the groups are (3) evaluated after 14 days and again after 28 days to determine a percentage of plants killed based on application of the Compositions. The Compositions are applied according to the protocol described above. The mean percent kill of each group and each plot is set forth in FIG. 7 along with letters from the Duncan's new multiple range test (MRT), as described above.

The data set forth in FIGS. 6 and 7 illustrates that use of a polyethyleneimine of this invention tends to increase rainfastness of the Compositions. More specifically, and as described above, the polyethyleneimine tends to have decreased mobility in water as compared to related lower molecular weight analogs and tends to have an affinity for long chain fatty acids (e.g. having 12 to 20 carbon atoms). This decreased mobility in water minimizes the rate at which water solubilizes and transports the polyethyleneimine which correlates to increased rainfastness, i.e., increased ability for the pesticide composition to resist being rinsed off of a target.

The decreased rinse off also decreases potential toxicity to animals such as fish. Moreover, the hydrophobicity of the polyethyleneimine increases the attraction of the pesticide composition to plant leaves which further increases rainfastness and ultimate efficacy of the pesticide compositions.

It is to be understood that one or more of the values described above may vary by ±5%, ±10%, ±15%, ±20%, ±25%, ±30%, etc. so long as the variance remains within the scope of the invention. It is also to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The subject matter of all combinations of independent and dependent claims, both singly and multiply dependent, is herein expressly contemplated but is not described in detail for the sake of brevity. The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A pesticide composition having improved rainfastness, said composition comprising:
A. an active component chosen from glufosinate, glyphosate, and combinations thereof; and
B. polyethyleneimine having a weight average molecular weight of at least about 750,000 g/mol.

2. A pesticide composition as set forth in claim 1 wherein said polyethyleneimine has a weight average molecular weight of from about 750,000 g/mol to about 2,000,000 g/mol.

3. A pesticide composition as set forth in claim 1 wherein said polyethyleneimine has a weight average molecular weight of from about 1,000,000 g/mol to about 2,000,000 g/mol.

4. A pesticide composition as set forth in claim 1 wherein said polyethyleneimine has a weight average molecular weight of about 2,000,000 g/mol.

5. A pesticide composition as set forth in claim 1 further comprising water wherein said polyethyleneimine is present in an amount of from about 0.0001 weight percent to less than about 0.1 weight percent, based on a total weight of said composition.

6. A pesticide composition as set forth in claim 1 wherein said active component is present in an amount of from about 0.00001 weight percent to about 10 weight percent, based on a total weight of said composition.

7. A pesticide composition as set forth in claim 1 further comprising water wherein said active component is present in an amount of from about 0.00001 weight percent to about 10 weight percent, based on a total weight of said composition.

8. (canceled)

9. A pesticide composition as set forth in claim 1 consisting essentially of said active component, said polyethyleneimine, and water.

10. A method of applying the pesticide composition as set forth in claim 1, wherein the pesticide composition optionally further comprises water and wherein said method comprises the step of spraying the pesticide composition onto a target.

11. A pesticide composition having improved rainfastness, said composition comprising:
A. an active component chosen from glufosinate, glyphosate, and combinations thereof;
B. polyethyleneimine having a weight average molecular weight of about 2,000,000 g/mol; and
C. water;
wherein said polyethyleneimine is present in an amount of from about 0.0001 weight percent to less than about 0.1 weight percent, based on a total weight of said composition.

12. (canceled)

13. A pesticide composition as set forth in claim 11 wherein said active component is present in an amount of from about 0.00001 weight percent to about 10 weight percent, based on a total weight of said composition.

14. A pesticide composition as set forth in claim 11 consisting essentially of said active component, said polyethyleneimine, and said water.

15. A method of forming a pesticide composition having improved rainfastness and comprising (A) an active component and (B) polyethyleneimine having a weight average molecular weight of at least about 750,000 g/mol, said method comprising the steps of:
(I) providing the (A) active component;
(II) providing the (B) polyethyleneimine; and
(III) combining (A) and (B) to form the pesticide composition,
wherein the active component is chosen from glufosinate, glyphosate, and combinations thereof.

16. A method as set forth in claim 15 wherein the pesticide composition further comprises (C) water, said method further comprises the step of providing the (C) water, and said step of combining is further defined as combining (A), (B), and (C) to form the pesticide composition.

17. A method as set forth in claim 15, (B), and (C) are combined in a spray tank.

18. A method as set forth in claim 15 further comprising the step of adding an additional amount of water to the combination of (A), (B), and (C) in a spray tank.

19. A method as set forth in claim 15 wherein (A) and (B) are combined prior to combination with (C).

20. A pesticide composition as set forth in claim 1 further comprising water wherein said polyethyleneimine is present in an amount of from 0.0001 weight percent to 0.01 weight percent, based on a total weight of said composition.

21. A method as set forth in claim 16 wherein the polyethyleneimine is present in an amount of from 0.0001 weight percent to less than about 0.1 weight percent, based on a total weight of the composition.

22. A method as set forth in claim 16 wherein the polyethyleneimine is present in an amount of from 0.0001 weight percent to 0.01 weight percent, based on a total weight of the composition.
